(19) United States
(12) Patent Application Publication
(10) Pub. No.: US 2025/0335764 A1
(43) Pub. Date: Oct. 30, 2025

(54) CLOUD INSTANCE TYPE RECOMMENDATIONS

(71) Applicant: NetApp, Inc., San Jose, CA (US)

(72) Inventors: Idan Schwartz, Tel Aviv (IL); Guy Yariv, Tel Aviv (IL); Tal OHAYON, Tel Aviv (IL)

(73) Assignee: NetApp, Inc., San Jose, CA (US)

(21) Appl. No.: 18/924,802

(22) Filed: Oct. 23, 2024

Related U.S. Application Data
(60) Provisional application No. 63/639,431, filed on Apr. 26, 2024.
(60) Provisional application No. 63/696,982, filed on Sep. 20, 2024.

(51) Int. Cl. G06N 3/08; H04L 67/10

(52) U.S. Cl. CPC G06N 3/08; H04L 67/10

(57) ABSTRACT

Systems and methods for making instance-type recommendations are provided. In various examples, an instance type recommendation system (internal or external to a cloud) provides users (cloud customers) with instance type recommendations and may automatically adjust their instance type groups (ITGs). The instance type recommendations may take into consideration other users with similar requirements and/or be based on frequency of co-occurrence of an instance type of the user at issue with one or more other instance types used by other users as reflected by their respective current ITGs. For example, a multi-layer perceptron (MLP) neural network may be trained by breaking instance types down into respective attributes and causing the MLP to encode the attributes as features and the training may make use of a triplet loss function that minimizes a distance between an anchor and a positive input while maximizing a distance between the anchor and a negative input.

### CROSS-REFERENCE TO RELATED PATENTS

This application claims the benefit of priority of U.S. Provisional Application No. 63/639,431, filed on Apr. 26, 2024 and of U.S. Provisional Application No. 63/696,982, filed on Sep. 20, 2024, both of which are hereby incorporated by reference in their entirety for all purposes.

### BACKGROUND

### Field

Various embodiments of the present disclosure generally relate to cloud instance types of cloud service providers and machine-learning (ML) technology. In particular, some embodiments relate to an approach for training an ML model based on data relating to instance-type groups (ITGs) authorized by customers of a cloud service provider for hosting their cloud workloads to make new instance type recommendations to a given customer.

### Description of the Related Art

Since it may be costly and inefficient for organizations to maintain physical server resources on premises, many organizations are turning to the use of cloud environments or cloud computing platforms (e.g., Amazon Web Services (AWS), Google Cloud Platform (GCP), and Microsoft Azure) offered by the respective cloud providers (e.g., Amazon, Google, and Microsoft) as an alternative to maintaining such physical server resources (or a supplement thereto). For example, cloud consumers may make use of the hardware maintained by the cloud providers in their data centers via virtual access (in the form of one or more cloud instances) to such physical server resources. As described further below, a cloud instance (a manifestation of cloud instance type) abstracts underlying physical computing infrastructure of the cloud service provider using virtual machine technology and presents a collection of one or more server resources as a virtual server for use by a cloud customer on which the customer may run their workloads.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an operational environment according to some embodiments of the present disclosure.

FIG. 2 is a block diagram illustrating various functional units of an instance-type recommendation system in accordance with various embodiments of the present disclosure.

FIG. 3 is a block diagram illustrating an example of an ML classification model in accordance with one or more embodiments.

FIG. 4 is a high-level flow diagram illustrating a set of operations that may be part of an instance-type recommendation pipeline in accordance with various embodiments of the present disclosure.

FIG. 5 is a flow diagram illustrating a set of operations for training a machine-learning (ML) model in accordance with an embodiment of the present disclosure.

FIG. 6 is a flow diagram illustrating a set of operations for providing an instance-type recommendation in accordance with an embodiment of the present disclosure.

FIG. 7 illustrates an example computer system in which or with which embodiments of the present disclosure may be utilized.

### DETAILED DESCRIPTION

Systems and methods are described for making instance-type recommendations. Many cloud solutions require the definition of a group of diverse cloud resources (e.g., an Instance Type Group (ITG)) for running applications with better availability and cost efficiency. For example, when utilizing sparse resources with limited availability, such as spot instances, one can select the instance type with the lowest likelihood of interruption.

Cloud environments or cloud computing environments are complicated with many different cloud instance types offered by respective cloud providers. Adding to the complexity, new technologies are continuously being added to physical servers resulting in the introduction of new cloud instance types by cloud providers on a regular basis (e.g., monthly). This results in an ever increasing number of different cloud instance types that are available to customers in connection with running their workloads. For example, AWS alone offers over 300 Amazon Elastic Compute Cloud (EC2) instance types across five Amazon EC2 instance families, each with varying resource and performance focuses. While such a diverse array of choices is generally beneficial to consumers, in this context, in which cloud providers generally require their customers to specify a whitelist of acceptable instance types on which the cloud provider can run customer workloads, the number of cloud instance types across the various cloud providers can be problematic and overwhelming. For example, in order to properly match a particular instance type to the workload demands of a customer, the customer may find themselves digging through hardware specifications of tens of instance types just for a single family of instances recommended by the cloud provider for the general type of application at issue. Despite the general availability of cloud-provider hardware specifications for each of the instance types they make available for use, it may still be difficult for cloud customers to distinguish among the sometimes subtle differences in features and capabilities of various instance types. Additionally, cloud customers may not become aware of newly introduced instance types by their cloud provider and may continue to use older instance types that may be less efficient for their workloads. Furthermore, there may be some instance types that are unsuitable for accommodating a customer workload. Should such an unsuitable instance type be included within their ITG (or whitelist), the customer may experience downtime if and when their workload is moved to a cloud instance of the unsuitable instance type.

Embodiments described herein seek to address or at least mitigate the difficulties cloud customers may experience in selecting appropriate instance types for their workloads. For example, the proposed instance type recommendation system may provide users (cloud customers) with instance type recommendations and offer users the flexibility to manually modify their ITGs or automatically adjust their ITGs based on the recommendations. Numerous potential approaches for making instance type recommendations are contemplated herein. The instance type recommendations may be generated by considering other users with similar requirements (e.g., common specified instances and/or common workload features) or based on frequency of co-occurrence of an instance type of the ITG customer at issue with one or more other instance types used by other customers as reflected by their respective current ITGs. For example, depending on the information available to the recommendation system regarding customers (e.g., attributes of the customers) of the recommendation system and/or their respective workload requirements, instance type recommendations provided to a given customer of a cloud service provider (user of a cloud platform) may be based on (i) an ITG specified by the given customer and ITGs available from the cloud platform; and/or (ii) current and/or historical data relating to ITGs utilized by other customers of the cloud service provider.

According to one embodiment, a recommendation system is provided that suggests addition of one or more new instance types to (or removal of one or more existing instance types from) a cloud customer's current ITG based on one or more of attributes of the customer, attributes of other customers of the cloud service provider, ITGs utilized by the other customers, attributes of the instance types, and the cloud customer's current ITG. For example, in a simple case, assuming user Bob and user Alice have similar requirements (e.g., determined based on similar attributes of their respective organizations or determined based on similar attributes of instance types of their respective ITGs), if user Bob has the ITG {A, B, C} and user Alice has the ITG {A, B}, it may be recommended that Alice add instance type C to her ITG. In a more advanced scenario, if Bob's ITG is {A, B, C} and Alice's ITG is {D, G}, but instance types D and G share similar features with A and B (e.g., similar hardware specifications), the proposed recommendation system can still detect the correlation and recommend to Alice the addition of instance type C to her ITG. Furthermore, in a learning-based approach, the algorithm can identify that Bob's ITG {A, B} correlates with Alice's ITG {D, G} even without an exact match in hardware requirements, based on the observation that many users who have ITG including instance types {A, B} also have included instance types {D, G} in their ITGs or that users with instance types {D, G} specified in the ITGs also commonly specify instance type {C}. This learning can be accomplished using large-scale user data as described further below.

While various examples may be described with reference to a particular cloud service provider (e.g., Amazon), a particular cloud environment or platform (e.g., AWS), and particular families of cloud instances and cloud instance types offered by the particular cloud provider, it is to be appreciated the methodologies described herein are equally applicable to other cloud providers (e.g., Google and Microsoft) and their respective cloud environments and associated cloud instance types.

Various embodiments of the present technology provide for a wide range of technical effects, advantages, and/or improvements to computing systems and components. For example, various embodiments may include one or more of the following technical effects, advantages, and/or improvements: 1) use of non-routine and unconventional operations to facilitate more effective and efficient usage of cloud resources of a cloud platform by its customers; 2) unconventional use of multi-layer perceptron (MLP) neural networks (which are typically used for applications involving image, audio, and speech recognition, natural language processing, and time-series prediction) as the core of an instance type recommendation system; 3) enhancing the training of the MLP neural network using an ML loss function that minimize the distance between the anchor and the positive input while maximizing the distance between the anchor and the negative input; 4) use of non-routine and unconventional training and/or feature engineering (e.g., representing instance types in terms of their respective attributes as features during training of an ML model) to facilitate improved ability on the part of the ML model to identify similarity among and between various instance types available from a given cloud platform; 5) improvements to the technological process of evaluating and selecting optimal instance types for inclusion in a cloud customer's ITG; 6) performance of automated ITG optimization/tuning on behalf of cloud customers based on recommendations received from an instance type recommendation system; 7) increasing system or service availability by facilitating appropriate expansion of a cloud customer's ITGs based on instance type recommendations that may take into consideration, among other things, one or more of attributes of instance types, attributes of the customer, attributes of other customers of the cloud service provider, ITGs utilized by other customers of the cloud service provider, and a cloud customer's current ITG; and 8) reducing system or service downtime by avoiding selection of unsuitable instance types for inclusion within a cloud customer's ITG.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud,” “cloud system,” “cloud platform,” “cloud computing environment,” and/or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a hyperscaler (which may also be referred to herein as a cloud service provider or simply a cloud provider) (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), Infrastructure-as-a-Service (IaaS), and/or Function-as-a-Service (FaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, “cloud infrastructure” or simply “infrastructure” generally refers to cloud services, infrastructure, platforms, or software that are hosted by a cloud service provider and made available to users through the Internet.

As used herein, a “cloud instance” or simply an “instance” generally refers to a virtual server (or virtual machine) from a public cloud hosted on a cloud service provider's infrastructure. Since it may be costly and inefficient for organizations to maintain physical server resources on premises, many organizations are turning to cloud providers as an alternative (or supplement) to maintaining such physical server resources by making use of the hardware maintained by cloud providers in their data centers via virtual access (in the form of one or more cloud instances) to such physical server resources. For example, a cloud instance generally abstracts underlying physical computing infrastructure of the cloud service provider using virtual machine technology and presents a collection of one or more server resources (e.g., processing resources, memory resources, storage resources, and/or networking resources) of underlying physical computing infrastructure (e.g., a physical server) as a virtual server for use by the customer or consumer (e.g., an individual end user or an organization) on which the customer may run their workloads. Cloud instances may include reserved, on-demand, and/or spot instances, which may be offered by a cloud provider in accordance with different pricing models. For example, a cloud customer may make a reservation of cloud resources and capacity (e.g., for one or three years) and purchase a reserved instance at contract prices, plus hourly rates. For on-demand instances, a cloud customer generally pays for cloud resources used (e.g., measured in time or based on resource capacity actually used) with no long-term commitment and such instances may automatically scale up or down with changing workloads. Finally, spot instances represent instances that use spare capacity that may be made available by cloud providers for steep discounts compared to prices of on-demand instances. Spot instances may be interruptible by the cloud provider (with short notice). So, while spot instances use the same underlying instances as on-demand and reserved instances, they are best suited for fault-tolerant, flexible workloads. Non-limiting examples of reserved instances, on-demand instances, and spot instances include Amazon EC2 reserved instances, Amazon EC2 on-demand instances, and Amazon EC2 spot instances, respectively.

As used herein, a “cloud instance type” or simply an “instance type” generally refers to a particular type of a cloud instance available from a particular cloud service provider that has a specified set of attributes or characteristics. Different instance types may have varying combinations of compute (e.g., central processing unit (CPU) and/or graphics processing unit (GPU)), memory, storage, and networking capacity, across one or more size options, thereby providing customers with the flexibility to choose the appropriate mix of resources that are appropriate for their particular workloads. AWS broadly groups cloud instance types into specified groupings or families of Amazon EC2 instance types, including general purpose instances, compute optimized instances, memory optimized instances, accelerated computing instances, storage optimized instance, and High Performance Computing (HPC) optimized cloud instances. As described further below, non-limiting examples of general purpose instance types available from AWS include Amazon EC2 M7g, M7i, M7a, M6g, M6i, M6 in, M6a, M5, M5n, M5a, and other instance types. The general purpose cloud instances are recommended by Amazon for use in connection with general purpose applications (such as web servers and code repositories) that use compute, memory, and network resources in a somewhat equal proportions. Various other general purpose cloud instance types, compute optimized cloud instance types, memory optimized cloud instance types, accelerated computing cloud instance types, storage optimized cloud instance types, and HPC optimized cloud instance types are also available for use via AWS for applications having different resource demands. Furthermore, similar broad categories and specific cloud instance types are also available from other cloud service providers, including, but not limited to Google (via the Google Cloud Platform), Microsoft (via Microsoft Azure), Oracle (via Oracle Cloud), and IBM (via the IBM Cloud platform). As such, while for convenience, various examples described herein may be explained with reference to AWS instance types, it is to be appreciated the methodologies described herein are generally applicable to instance types of any cloud service provider.

As used herein, an “Instance Type Group” or “ITG” generally refers to a set of one or more instance types. In various examples described herein, an ITG may include a list of instance types that are specifically authorized for use by a cloud platform to run a particular cloud customer's workloads. In this context, an ITG may be thought of as a whitelist of approved instance types on which the customer's workloads may be run.

As used herein, “attributes” of a cloud instance generally refer to characteristic of a cloud instance that might be useful in connection with identifying commonality/similarity between or among cloud instances and/or applicability to particular types of workloads. In the context of AWS, non-limiting examples of the attributes of an instance type include the instance family (e.g., general purpose, compute optimized, memory optimized, etc.), the generation (e.g., current vs. previous), special features (e.g., extra capacity, network optimized, AMD processors, AWS Graviton processors, Intel processors, instance store volumes, block storage optimization, high frequency, etc.), the type of virtual central processing unit (vCPU), GPU type (e.g., NVIDIA Tesla M60, T4, A10G, V100, A100, etc.), memory capacity, elastic network adapter (ENA) type, network performance, maximum number of elastic network interfaces (ENIs), virtualization type (e.g., paravirtual or hardware virtual machine), architecture type (e.g., i386, 64-bit ARM architecture, 64-bit x86 architecture, etc.), hypervisor (e.g., bare metal vs. hosted), storage capacity, vCPU information (e.g., the type of processor, number of cores, clock rate, and/or special features, etc.) and/or other hardware specifications.

As used herein, “attributes” of a customer generally refer to characteristic of a customer that might be useful in connection with identifying commonality/similarity between or among customers and/or identifying the potential for commonality/similarity between or among the types of workloads they run. Non-limiting examples of customer attributes may include one or more of: the size of the customer organization, whether the organization is public or private, financial metrics (e.g., revenue, net profit, burn rate) of the customer organization (e.g., quarterly or annually), the industry (e.g., automotive, finance, healthcare, manufacturing, insurance, real estate, technology, etc.) in which the customer operates, the company's domain or field of business (e.g., artificial intelligence (AI), gaming, etc.), the customer's demand for various cloud resources and/or the cloud system as a whole, the amount the customer spends on various cloud resources and/or the cloud system as a whole, the amount of time the customer makes use of various cloud resources and/or the cloud system as a whole

### Example Operational Environment

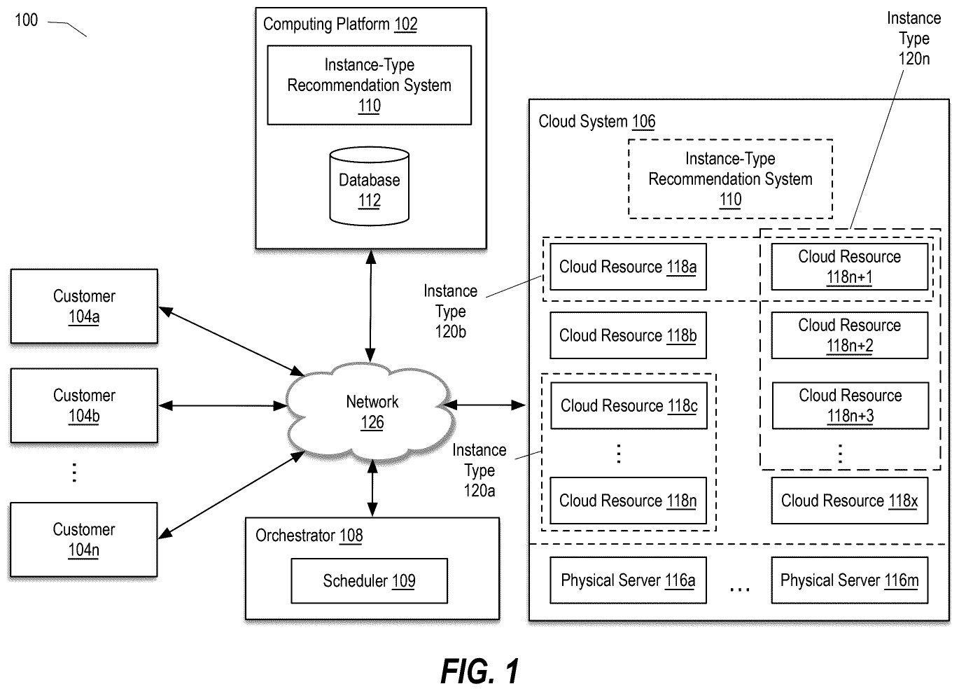

FIG. 1 is a block diagram illustrating an operational environment 100 according to some embodiments of the present disclosure. The operational environment 100 may include, among other things, a computing platform 102, one or more cloud customers (e.g., customers 104a-n), a cloud system 106, and an orchestrator 108. These aspects of the operational environment 100 may communicate with each other via a network 126. The network 126 may be, for example, the Internet, a local area network, a wide area network, and/or a wireless network (to name a few examples). The network 126 may include a variety of transmission media including cables, optical fibers, wireless routers, firewalls, switches, gateways, and/or other devices to facilitate communications between one or more of the aspects of the environment 100.

Cloud system 106 may be a provider of cloud infrastructure for one or more of the cloud customers. Cloud system 106 may represent a cloud platform of a cloud provider through which the cloud provider offers a variety of cloud computing solutions, such as IaaS, SaaS, and/or PaaS as some examples. For example, cloud system 106 may be a public cloud provider, non-limiting examples of which include AWS, Microsoft Azure, GCP, and the IDB Cloud platform. These are by way of illustration. The cloud system 106 may represent a multi-tenant cloud provider that may host a variety of virtualization tools that cloud customers may request to host or otherwise run one or more applications (e.g., via the network 126 and/or orchestrator 108). Alternatively, the cloud system 106 may represent a private cloud provider, such as an enterprise cloud for a given organization.

Cloud system 106, generally, may provide infrastructure including any set of resources used for executing one or more containers, virtual machines, or other hosted virtualization tool. Resources may include compute resources (e.g., CPU and/or GPU resources), memory resources, caching resources, storage space resources, networking or communication capacity resources, etc. that a virtualization tool such as a container may use for execution of one or more workloads for cloud customers. Examples of these resources are illustrated in FIG. 1 as cloud resources 118a-x of cloud system 106. The cloud system 106 may offer cloud instances that include any number of cloud resources in any of a variety of combinations (e.g., as shown by instance types 120a-n). As just one example, a set of one or more of cloud resources 118a-x may be offered in the form of an AWS EC2 instance (e.g., representing virtualized capacity of compute, memory, storage, and networking resources of underlying physical servers 116a-m). Non-limiting examples of attributes of various non-limiting examples of AWS EC2 instances are provided below with reference to Tables 1-10.

The usage model for the cloud system 106 may vary from customer-to-customer. For example, customer 104a (or another of customers 104b-n, but referring to 104a for simplicity herein) may run one or more virtualization layers, such as virtual machines and/or containers on one or more cloud resources 118a-x of cloud system 106, via network 126. For example, a container may use a level of system level virtualization, such as by packaging up application code and its dependencies (e.g., system tools, system libraries and/or settings, etc.) so that the hosted application can be executed reliably on one or more computing platforms of the cloud system 106 (as an example). Some examples of software may include, for example, Red Hat® OpenShift®, Docker® containers, chroot, Linux® VServer, FreeBSD® Jails, HP-UX® Containers (SRP), VMware ThinApp®, etc. Containers may run on the cloud system 106 on a host operating system directly, or may be run via another layer of virtualization (such as within a virtual machine).

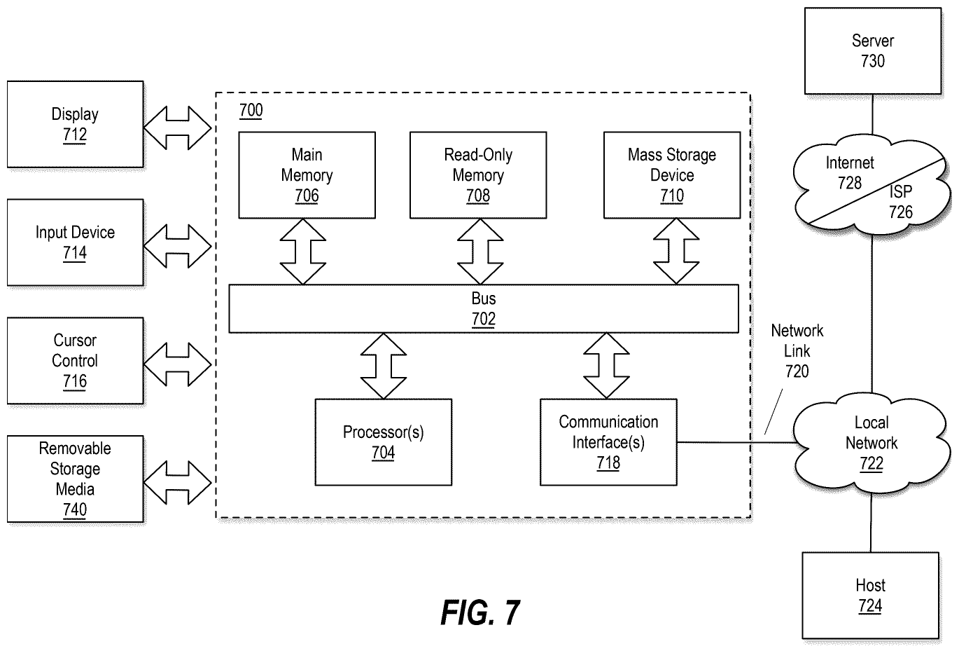

Cloud customers may orchestrate one or more containers using the cloud resources 118a-x using orchestrator 108. Orchestration may refer to scheduling containers within a predetermined set (e.g., a cloud instance of one of instance types 120a-n of available infrastructure represented by the cloud resources 118a-x. The orchestrator 108 may be used to determine the required infrastructure based upon the needs of containers being executed/requested for execution. For example, orchestrator 108 may map each container to a different set of cloud resources 118a-x, such as by selecting a set of containers to be deployed on each cloud resource 118a-x that is still available for use. Examples of orchestrator 108 may include Kubernetes®, Docker Swarm®, AWS Elastic Container Service™, etc. Generally, it may refer to a container orchestrator that is executed on a host system (e.g., one of physical servers 116a-m) of cloud system 106, for example, in the form of the computer system described below with reference to FIG. 7. The orchestrator 108 may further include a scheduler 109. Scheduler 109 may be used to make an actual request for infrastructure and allocation of containers to the infrastructure to the cloud system 106. An example of a scheduler 109 may include a Kubernetes® scheduler, which may execute on a host within network 126, either on the same hardware resources as orchestrator 108 or on other hardware and/or software resources.

The environment 100 may further include computing platform 102. In the context of the present example, the computing platform 102 may be part of a platform that is separate and independent from the cloud system 106. For example, the computing platform may be a third-party cloud analytics or recommendation platform utilized by some subset of cloud customers. In other examples the computing platform 102 may be part of a larger service offering that goes beyond cloud analytics and recommendations and also facilitates automation and/or optimization of a cloud customer's cloud infrastructure in AWS, Azure, GCP, or the like. Depending on the particular relationship between cloud customers and the computing platform 102, the computing platform 102 may observe various interactions between the cloud customers and the cloud system 106, facilitate such interactions, and/or perform monitoring of various aspects of the cloud system 106 on behalf of cloud customers, for example, to help cloud customers make optimal use of cloud infrastructure resources and/or provide recommendations to cloud customers regarding one or more instance types they should consider adding to (or removing from) their ITGs.

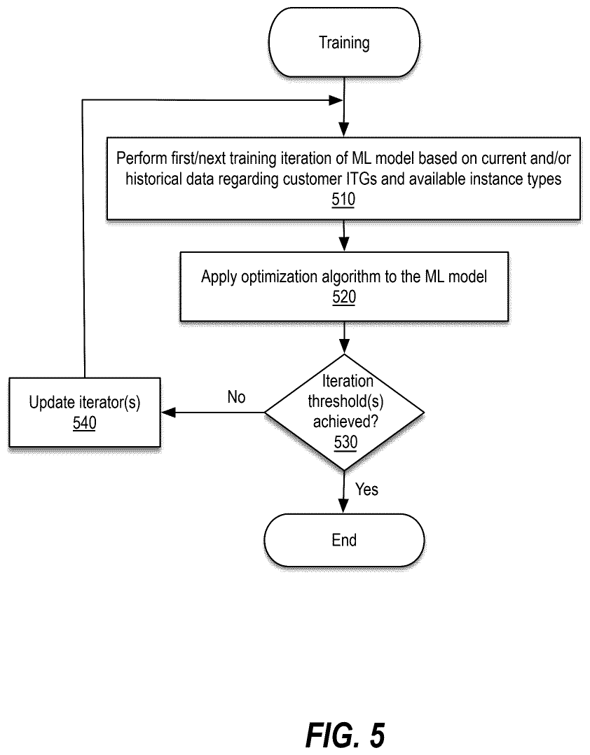

In the context of the present example, the computing platform 102 is shown including an instance-type recommendation system 110 and a database 112. These may be executed by a processor, multiple processors, or one or more computer systems, for example, in the form of the computer system described below with reference to FIG. 7. In one embodiment, as a result of its relationship with cloud customers, the computing platform 102 may receive (e.g., directly from cloud customers or via the cloud system 106) and collect over time current and/or historical information relating to instance type usage or ITGs of the cloud customers, attributes (e.g., hardware specifications) of instance types offered by the cloud service 106, attributes of cloud customers, etc. For example, computing platform 102 may collect information regarding ITGs used by cloud customers over time as they deploy workloads in the cloud and/or as they request and use cloud resources 118a-x. Such current and/or historical information may be stored in the database 112 and used to facilitate training of the instance-type recommendation system 110, for example, as described below with reference to FIG. 5. In an alternative embodiment, the instance-type recommendation system 110 may be implemented within cloud system 106 as represented by the instance-type recommendation system 110 being depicted within cloud system 106 with a dashed-outlined box. Such an embodiment would facilitate instance type selection, for example, by a cloud platform feature (e.g., Amazon EC2 Fleet) that performs automatic scaling, launching, managing, and/or monitoring of fleets of instances on behalf of its cloud customers.

According to some embodiments, computing platform 102 may also collect information regarding instance market data over time. In some examples, one or more of cloud customers may request a variety of cloud resources 118a-x at a variety of price points, depending on what is offered by cloud system 106 (as an example of one or more cloud providers) at any given point in time. For example, cloud system 106 as a cloud provider may offer different pricing options depending on demand. Some options may include reservations for future use (such as for a specified time period) of a cloud instance of a given instance type (e.g., instance type 120a-n), which may include a discount as the cloud customer is paying for that reservation whether actually used or not. Another option may include an on-demand alternative, which may be more expensive because the cloud customer request resources on-demand without committing to any long-term use beyond an incremental amount (e.g., for the next hour). This may result in the cloud customer paying for on-demand resource(s) on an hour-by-hour (or other time interval) basis. Further still, the cloud customer may make use of spot instances, representing instances that use spare capacity that may be made available by cloud system 106 for significant discounts from on-demand instances.

While in the context of the present example, the database 112 is shown as being part of the computing platform 102, it is to be appreciated in other examples the database 112 may be in communication with the computing platform 102 (e.g., part of a separate computing platform, etc.).

### Example Instance-Type Recommendation System

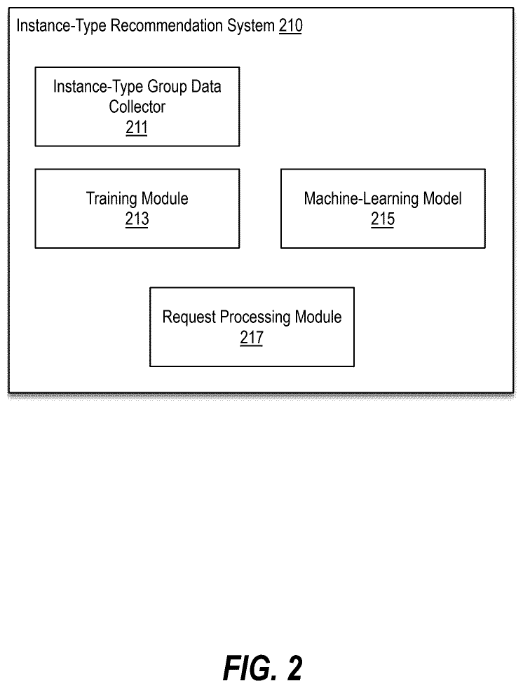

FIG. 2 is a block diagram illustrating various functional units of an instance-type recommendation system 210 in accordance with various embodiments of the present disclosure. In the context of the present example, the instance-type recommendation system 210 (which may be analogous to instance-type recommendation system 110) is shown including an instance-type group data collector 211, a training module, a machine-learning (ML) model 215, and a request processing module 217.

The instance-type group data collector 211 may be responsible for collecting data from cloud customers (e.g., customers 104a-n) and/or one or more cloud platforms (e.g., cloud system 106) that is helpful for providing instance-type recommendations to cloud customers. As a result of being involved in providing services to cloud customers, for example, as part of a computing platform (e.g., computing platform 102) providing cloud analytics and/or recommendations to cloud customers relating to their usage of one or more cloud platforms, the instance-type group data collector 211 may be in a position to collect valuable data directly from and/or on behalf of cloud customers from one or more cloud platforms. For example, in one embodiment, the instance-type group data collector 211 may receive (e.g., directly from cloud customers or via one or more cloud platforms) and persist to a database (e.g., database 112) information relating to instance type usage or ITGs of the cloud customers, attributes (e.g., hardware specifications) of instance types offered by the one or more cloud platforms, attributes of the cloud customers, etc.

The training module 213 may be responsible for training the ML model 215. In various examples described herein, rather than performing conventional coarse granularity training of the ML model 215 based on the instance types themselves as features, the training module 213 trains the ML model 215 based on certain discrete characteristics of the instance types to achieve finer granularity. For example, the training module 213 may retrieve information regarding current ITG usage (e.g., previously gathered and persisted by the instance-type group data collector 211) by cloud customers and represent the instance types within the ITGs in use by the cloud customers in terms of their respective attributes, including one or more of the instance family (e.g., general purpose, compute optimized, memory optimized, etc.), the generation (e.g., current vs. previous), special features (e.g., extra capacity, network optimized, AMD processors, AWS Graviton processors, Intel processors, instance store volumes, block storage optimization, high frequency, etc.), the type of virtual central processing unit (vCPU), GPU type (e.g., NVIDIA Tesla M60, T4, A10G, V100, A100, etc.), memory capacity, elastic network adapter (ENA) type, network performance, maximum number of elastic network interfaces (ENIs), virtualization type (e.g., paravirtual or hardware virtual machine), architecture type (e.g., i386, 64-bit ARM architecture, 64-bit x86 architecture, etc.), hypervisor (e.g., bare metal vs. hosted), storage capacity, vCPU information (e.g., the type of processor, number of cores, clock rate, and/or special features, etc.) and/or other hardware specifications. Advantageously, the use of more granular features to represent instance types allows the ML model 215 to more accurately learn similarities among and between various instance types. For example, the finer granularity provided by the underlying attributes of the instance types facilitates finding of correlations by the ML model 215 among various signals that would not otherwise be visible without breaking the instance types down into more granular features.

The ML model 215 may be responsible for learning similarities among and between various instance types based on the training data provided by the training module 213 and performing inference processing responsive to requests received from the request processing module 217. As described below, in one example, the ML model 215 comprises a two-layer multi-layer perceptron (MLP) neural network trained using a loss function known as triplet-loss. The inference processing may serve as a search system for one or more suitable instance types to add to a given ITG provided as part of an inference request. According to one embodiment, inference processing may output a ranked list of one or more instance types available from a given cloud platform that are recommended to be added to the given ITG. The inference processing may also learn and identify instance types that may no longer be relevant (e.g., due to outdated hardware) and suggest their removal from the given ITG.

The request processing module 217 may be responsible for making inference requests of the ML model 215 on behalf of a given cloud customer. For example, when a cloud customer would like to receive a recommendation regarding one or more instance types recommended to be added to their current ITG, the cloud customer may request an instance-type recommendation from the instance-type recommendation system 210. Such an instance-type recommendation request may identify, among other parameters, the cloud provider for which the instance-type recommendation is desired and the cloud customer's current ITG.

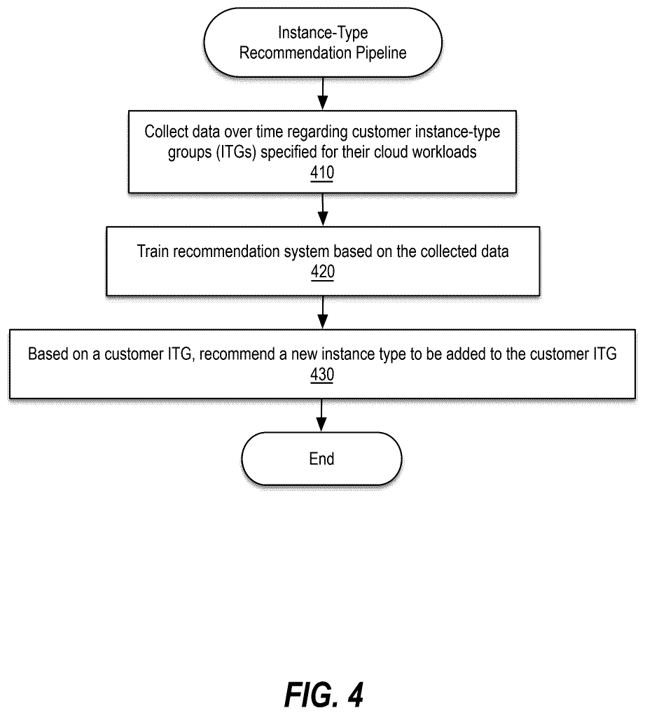

The various functional units and modules described above with reference to FIG. 2, and the processing described below with reference to the flow diagrams of FIGS. 4-6 may be implemented in the form of executable instructions stored on a machine readable medium and executed by one or more processing resources (e.g., one or more microcontrollers, microprocessors, central processing unit core(s), application-specific integrated circuits (ASICs), field programmable gate arrays (FPGAs), and the like and/or a combination thereof) and/or in the form of other types of electronic circuitry. For example, the processing may be performed by one or more virtual or physical computer systems of various forms, such as the computer system described with reference to FIG. 7 below.

### Example ML Model

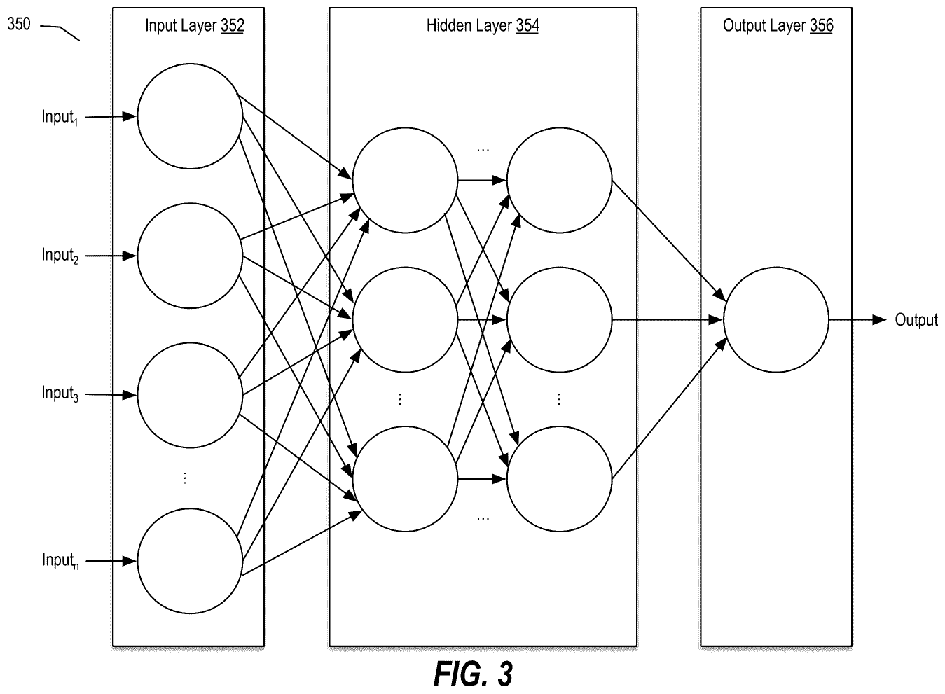

FIG. 3 is a block diagram illustrating an example of an ML model 350 in accordance with one or more embodiments. ML models are algorithms that can identify patterns or make predictions based on datasets. Unlike rule-based programs, ML models do not have to be explicitly coded and can evolve over time as new data enters the system. In one or more embodiments, the ML classification model 350 may be trained by a computing platform (e.g., computing platform 102), for example, of a service provider that facilitates efficient utilization of cloud resources (e.g., cloud resources 118a-x) of a cloud system (e.g., cloud system 106) by cloud customers (e.g., customers 104a-n) based on historical data collected directly from cloud customers or extracted from the cloud system as part of monitoring of the cloud system on behalf of the cloud customers. Alternatively, in an example in which an instance-type recommendation system (e.g., instance-type recommendation system 110) is implemented by the cloud system, the ML classification model 350 may be trained based on similar data already available to the cloud system by virtue of having direct interactions with its cloud customers.

In the context of the present example, the ML model 350 is shown as a network of nodes (or “neurons”) which are organized in layers (e.g., an input layer 352, one or more hidden layers 354, and an output layer 356). A non-limiting example of the ML model is a two-layer Multi-Level Perceptron (MLP) architecture with Rectified Linear Unit (ReLU) activation, trained using the triplet loss approach as described further below. An example of use of the triplet loss approach is described in Hoffer, Elad, and Nir Ailon. “Deep metric learning using triplet network.” Similarity-Based Pattern Recognition: Third International Workshop, SIMBAD 2015, Copenhagen, Denmark, Oct. 12-14, 2015. Proceedings 3. Springer International Publishing, 2015, which is hereby incorporated by reference in its entirety for all purposes.

In the context of the present example, based on the predictors (or inputs) provided to the input layer 352, forecasts (or outputs) are emitted by the output layer 356. Coefficients (not shown) associated with each of the predictors are generally referred to as weights. The forecasts are obtained by a combination (in this case, a non-linear combination) of the inputs. The weights may be selected using a learning algorithm that minimizes a cost function (e.g., mean absolute error, mean squared error, root mean squared error, etc.) or a loss function (e.g., the triplet loss function or other relevant loss types, like contrastive loss, which aims to maximize the agreement between positive pairs (instances from the same sample) and minimize the agreement between negative pairs (instances from different samples) in the learned embedding space). Additionally, it is to be appreciated there are other ways of addressing learning retrieval problems in the context of ML. The example ML model 350 depicted in FIG. 3 is representative of a multilayer feed-forward network, where each layer of nodes receives inputs from the previous layers. The outputs of the nodes in one layer are inputs to the next layer. The inputs to each node are combined using a weighted linear combination. The result is then modified by a nonlinear function before being output.

In general, ML classification algorithms may be used to predict a discrete outcome (y) using independent variables (x). ML has a variety of use-cases in different domains. Subscription-based media streaming platforms like Netflix and Spotify, for instance, use ML to recommend content to users based on their respective activity on the platform. In the context of various embodiments described herein, an ML classification model (e.g., ML classification model 350) may be trained by the computing platform, for example, based on historical or current data collected directly from cloud customers or extracted from the cloud system and applied by the computing platform responsive to a request for an instance type recommendation received from a given customer of a cloud service provider (user of a cloud platform) and based on (i) an ITG of the given customer; and (ii) current and/or historical data relating to ITGs utilized by other customers of the cloud service provider. For example, the recommendation may be based on training of the ML model 150 based on one or more of attributes of other customers of the cloud service provider, ITGs utilized by the other customers, and attributes of the instance types and an inference request with one or more of attributes of the given customer and the given customer's current ITG as inputs (e.g., one or more of input₁ to inputₙ) to the input layer 352. As described further below, the output may represent a ranked list of suitable instance types recommended to the given customer to add to their ITG. Notably, the ML model 350 may also learn and identify instance types that may no longer be relevant (e.g., due to outdated hardware) and suggest their removal from the given customer's ITG.

While in the context of the present example, only one ML classification model 350 is shown, it is to be appreciated multiple different ML models may be employed. According to one embodiment, a different ML model may be trained by the computing platform for respective customers of each of multiple cloud service providers on a cloud platform basis. For example, a first ML model may be trained by the computing platform for making instance type recommendations relating to Amazon EC2 instances based on historical data gathered or collected relating to instance type usage of a set of customers of AWS, a second ML model may be trained by the computing platform for making instance type recommendations relating to GCP instances based on historical data gathered or collected relating to instance type usage of a set of customers of GCP, a third ML model may be trained by the computing platform for making instance type recommendations relating to Azure instances based on historical data gathered or collected relating to instance type usage of a set of customers of Azure, and so on.

The tables below are provided to illustrate the number and diversity of instance types (and corresponding non-limiting examples of attributes) that might be offered by a particular cloud platform. It is to be appreciated the following tables only represent a subset of available Amazon EC2 instance types in the general purpose family.

TABLE 1
Amazon General Purpose EC2 M7g Instances built
on the AWS Nitro System including AWS Graviton3
processors and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M7g/ | 1 | 4 | EBS- | up to 12.5 | up to 10 |
| medium | | | Only | | |
| M7g/ | 2 | 8 | EBS- | up to 12.5 | up to 10 |
| large | | | Only | | |
| M7g/ | 4 | 16 | EBS- | up to 12.5 | up to 10 |
| xlarge | | | Only | | |
| M7g/ | 8 | 32 | EBS- | up to 15 | up to 10 |
| 2xlarge | | | Only | | |
| M7g/ | 16 | 64 | EBS- | up to 15 | up to 10 |
| 4xlarge | | | Only | | |
| M7g/ | 32 | 128 | EBS- | 15 | 10 |
| 8xlarge | | | Only | | |
| M7g/ | 48 | 192 | EBS- | 22.5 | 15 |
| 12xlarge | | | Only | | |
| M7g/ | 64 | 256 | EBS- | 30 | 20 |
| 16xlarge | | | Only | | |
| M7g/ | 64 | 256 | EBS- | 30 | 20 |
| metal | | | Only | | |
| M7gd/ | 1 | 4 | 1 × 59 | up to 12.5 | up to 10 |
| medium | | | NVMe | | |
| | | | SSD | | |
| M7gd/ | 2 | 8 | 1 × 118 | up to 12.5 | up to 10 |
| large | | | NVMe | | |
| | | | SSD | | |
| M7gd/ | 4 | 16 | 1 × 237 | up to 12.5 | up to 10 |
| xlarge | | | NVMe | | |
| | | | SSD | | |
| M7gd/ | 8 | 32 | 1 × 474 | up to 15 | up to 10 |
| 2xlarge | | | NVMe | | |
| | | | SSD | | |
| M7gd/ | 16 | 64 | 1 × 950 | up to 15 | up to 10 |
| 4xlarge | | | NVMe | | |
| | | | SSD | | |
| M7gd/ | 32 | 128 | 1 × 1900 | 15 | 10 |
| 8xlarge | | | NVMe | | |
| | | | SSD | | |
| M7gd/ | 48 | 192 | 2 × 1425 | 22.5 | 15 |
| 12xlarge | | | NVMe | | |
| | | | SSD | | |
| M7gd/ | 64 | 256 | 2 × 1900 | 30 | 20 |
| 16xlarge | | | NVMe | | |
| | | | SSD | | |
| M7gd/ | 64 | 256 | 2 × 1900 | 30 | 20 |
| metal | | | NVMe | | |
| | | | SSD | | |

TABLE 2
Amazon General Purpose EC2 M7i Instances built
on the AWS Nitro System including Intel Xeon Scalable
processors and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M7i/ | 2 | 8 | EBS- | up to 12.5 | up to 10 |
| large | | | Only | | |
| M7i/ | 4 | 16 | EBS- | up to 12.5 | up to 10 |
| xlarge | | | Only | | |
| M7i/ | 8 | 32 | EBS- | up to 12.5 | up to 10 |
| 2xlarge | | | Only | | |
| M7i/ | 16 | 64 | EBS- | up to 12.5 | up to 10 |
| 4xlarge | | | Only | | |
| M7i/ | 32 | 128 | EBS- | 12.5 | 10 |
| 8xlarge | | | Only | | |
| M7i/ | 48 | 192 | EBS- | 18.75 | 15 |
| 12xlarge | | | Only | | |
| M7i/ | 64 | 256 | EBS- | 25 | 20 |
| 16xlarge | | | Only | | |
| M7i/ | 96 | 384 | EBS- | 37.5 | 30 |
| 24xlarge | | | Only | | |
| M7i/ | 192 | 768 | EBS- | 50 | 40 |
| 48xlarge | | | Only | | |
| M7i/ | 96 | 384 | EBS- | 37.5 | 30 |
| metal- | | | Only | | |
| 24xl | | | | | |
| M7i/ | 192 | 768 | EBS- | 50 | 40 |
| metal- | | | Only | | |
| 48xl | | | | | |

TABLE 3
Amazon General Purpose EC2 M7a Instances built
on the AWS Nitro System including AMD EPYC
processors and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M7a/ | 1 | 4 | EBS- | up to 12.5 | up to 10 |
| medium | | | Only | | |
| M7a/ | 2 | 8 | EBS- | up to 12.5 | up to 10 |
| large | | | Only | | |
| M7a/ | 4 | 16 | EBS- | up to 12.5 | up to 10 |
| xlarge | | | Only | | |
| M7a/ | 8 | 32 | EBS- | up to 12.5 | up to 10 |
| 2xlarge | | | Only | | |
| M7a/ | 16 | 64 | EBS- | up to 12.5 | up to 10 |
| 4xlarge | | | Only | | |
| M7a/ | 32 | 128 | EBS- | 12.5 | 10 |
| 8xlarge | | | Only | | |
| M7a/ | 48 | 192 | EBS- | 18.75 | 15 |
| 12xlarge | | | Only | | |
| M7a/ | 64 | 256 | EBS- | 25 | 20 |
| 16xlarge | | | Only | | |
| M7a/ | 96 | 384 | EBS- | 37.5 | 30 |
| 24xlarge | | | Only | | |
| M7a/ | 128 | 512 | EBS- | 50 | 40 |
| 32xlarge | | | Only | | |
| M7a/ | 192 | 768 | EBS- | 50 | 40 |
| 48xlarge | | | Only | | |
| M7a/ | 192 | 768 | EBS- | 50 | 40 |
| metal- | | | Only | | |
| 48xl | | | | | |

TABLE 4
Amazon General Purpose EC2 M6g Instances built on
the AWS Nitro System including ARM-based AWS Graviton2
processors and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M6g/ | 1 | 4 | EBS- | up to 10 | up to 4,750 |
| medium | | | Only | | |
| M6g/ | 2 | 8 | EBS- | up to 10 | up to 4,750 |
| large | | | Only | | |
| M6g/ | 4 | 16 | EBS- | up to 10 | up to 4,750 |
| xlarge | | | Only | | |
| M6g/ | 8 | 32 | EBS- | up to 10 | up to 4,750 |
| 2xlarge | | | Only | | |
| M6g/ | 16 | 64 | EBS- | up to 10 | 4,750 |
| 4xlarge | | | Only | | |
| M6g/ | 32 | 128 | EBS- | 12 | 9,000 |
| 8xlarge | | | Only | | |
| M6g/ | 48 | 192 | EBS- | 20 | 13,500 |
| 12xlarge | | | Only | | |
| M6g/ | 64 | 256 | EBS- | 25 | 19,000 |
| 16xlarge | | | Only | | |
| M6g/ | 64 | 256 | EBS- | 25 | 19,000 |
| metal | | | Only | | |
| M6gd/ | 1 | 4 | 1 × 59 | up to 10 | up to 4,750 |
| medium | | | NVMe | | |
| | | | SSD | | |
| M6gd/ | 2 | 8 | 1 × 118 | up to 10 | up to 4,750 |
| large | | | NVMe | | |
| | | | SSD | | |
| M6gd/ | 4 | 16 | 1 × 237 | up to 10 | up to 4,750 |
| xlarge | | | NVMe | | |
| | | | SSD | | |
| M6gd/ | 8 | 32 | 1 × 474 | up to 10 | up to 4,750 |
| 2xlarge | | | NVMe | | |
| | | | SSD | | |
| M6gd/ | 16 | 64 | 1 × 950 | up to 10 | 4,750 |
| 4xlarge | | | NVMe | | |
| | | | SSD | | |
| M6gd/ | 32 | 128 | 1 × 1900 | 12 | 9,000 |
| 8xlarge | | | NVMe | | |
| | | | SSD | | |
| M6gd/ | 48 | 192 | 2 × 1425 | 20 | 13,500 |
| 12xlarge | | | NVMe | | |
| | | | SSD | | |
| M6gd/ | 64 | 256 | 2 × 1900 | 25 | 19,000 |
| 16xlarge | | | NVMe | | |
| | | | SSD | | |
| M6gd/ | 64 | 256 | 2 × 1900 | 25 | 19,000 |
| metal | | | NVMe | | |
| | | | SSD | | |

TABLE 5
Amazon General Purpose EC2 M6i Instances built on the AWS
Nitro System including 3^{rd} Generation Intel Xeon Scalable
processors (Ice Lake) and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M6i/ | 2 | 8 | EBS- | up to 12.5 | up to 10 |
| large | | | Only | | |
| M6i/ | 4 | 16 | EBS- | up to 12.5 | up to 10 |
| xlarge | | | Only | | |
| M6i/ | 8 | 32 | EBS- | up to 12.5 | up to 10 |
| 2xlarge | | | Only | | |
| M6i/ | 16 | 64 | EBS- | up to 12.5 | up to 10 |
| 4xlarge | | | Only | | |
| M6i/ | 32 | 128 | EBS- | 12.5 | 10 |
| 8xlarge | | | Only | | |
| M6i/ | 48 | 192 | EBS- | 18.75 | 15 |
| 12xlarge | | | Only | | |
| M6i/ | 64 | 256 | EBS- | 25 | 20 |
| 16xlarge | | | Only | | |
| M6i/ | 96 | 384 | EBS- | 37.5 | 30 |
| 24xlarge | | | Only | | |
| M6i/ | 128 | 512 | EBS- | 50 | 40 |
| 32xlarge | | | Only | | |
| M6i/ | 128 | 512 | EBS- | 50 | 40 |
| metal | | | Only | | |
| M6id/ | 2 | 8 | 1 × 118 | up to 12.5 | up to 10 |
| large | | | NVMe | | |
| | | | SSD | | |
| M6id/ | 4 | 16 | 1 × 237 | up to 12.5 | up to 10 |
| xlarge | | | NVMe | | |
| | | | SSD | | |
| M6id/ | 8 | 32 | 1 × 474 | up to 12.5 | up to 10 |
| 2xlarge | | | NVMe | | |
| | | | SSD | | |
| M6id/ | 16 | 64 | 1 × 950 | up to 12.5 | up to 10 |
| 4xlarge | | | NVMe | | |
| | | | SSD | | |
| M6id/ | 32 | 128 | 1 × 1900 | 12.5 | 10 |
| 8xlarge | | | NVMe | | |
| | | | SSD | | |
| M6id/ | 48 | 192 | 2 × 1425 | 18.75 | 15 |
| 12xlarge | | | NVMe | | |
| | | | SSD | | |
| M6id/ | 64 | 256 | 2 × 1900 | 25 | 20 |
| 16xlarge | | | NVMe | | |
| | | | SSD | | |
| M6id/ | 96 | 384 | 4 × 1425 | 37.5 | 30 |
| 24xlarge | | | NVMe | | |
| | | | SSD | | |
| M6id/ | 128 | 512 | 4 × 1900 | 50 | 40 |
| 32xlarge | | | NVMe | | |
| | | | SSD | | |
| M6id/ | 128 | 512 | 4 × 1900 | 50 | 40 |
| Metal | | | NVMe | | |
| | | | SSD | | |

TABLE 6
Amazon General Purpose EC2 M6in Instances built on the AWS
Nitro System including 3^{rd} Generation Intel Xeon Scalable
processors (Ice Lake) and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M6in/ | 2 | 8 | EBS- | up to 25 | up to 25 |
| large | | | Only | | |
| M6in/ | 4 | 16 | EBS- | up to 30 | up to 25 |
| xlarge | | | Only | | |
| M6in/ | 8 | 32 | EBS- | up to 40 | up to 25 |
| 2xlarge | | | Only | | |
| M6in/ | 16 | 64 | EBS- | up to 50 | up to 25 |
| 4xlarge | | | Only | | |
| M6in/ | 32 | 128 | EBS- | 50 | 25 |
| 8xlarge | | | Only | | |
| M6in/ | 48 | 192 | EBS- | 75 | 37.5 |
| 12xlarge | | | Only | | |
| M6in/ | 64 | 256 | EBS- | 100 | 50 |
| 16xlarge | | | Only | | |
| M6in/ | 96 | 384 | EBS- | 150 | 75 |
| 24xlarge | | | Only | | |
| M6in/ | 128 | 512 | EBS- | 200 | 100 |
| 32xlarge | | | Only | | |
| M6in/ | 128 | 512 | EBS- | 200 | 100 |
| metal | | | Only | | |
| M6idn/ | 2 | 8 | 1 × 118 | up to 25 | up to 25 |
| large | | | NVMe | | |
| | | | SSD | | |
| M6idn/ | 4 | 16 | 1 × 237 | up to 30 | up to 25 |
| xlarge | | | NVMe | | |
| | | | SSD | | |
| M6idn/ | 8 | 32 | 1 × 474 | up to 40 | up to 25 |
| 2xlarge | | | NVMe | | |
| | | | SSD | | |
| M6idn/ | 16 | 64 | 1 × 950 | up to 50 | up to 25 |
| 4xlarge | | | NVMe | | |
| | | | SSD | | |
| M6idn/ | 32 | 128 | 1 × 1900 | 50 | 25 |
| 8xlarge | | | NVMe | | |
| | | | SSD | | |
| M6idn/ | 48 | 192 | 2 × 1425 | 75 | 37.5 |
| 12xlarge | | | NVMe | | |
| | | | SSD | | |
| M6idn/ | 64 | 256 | 2 × 1900 | 100 | 50 |
| 16xlarge | | | NVMe | | |
| | | | SSD | | |
| M6idn/ | 96 | 384 | 4 × 1425 | 150 | 75 |
| 24xlarge | | | NVMe | | |
| | | | SSD | | |
| M6idn/ | 128 | 512 | 4 × 1900 | 200 | 100 |
| 32xlarge | | | NVMe | | |
| | | | SSD | | |
| M6idn/ | 128 | 512 | 4 × 1900 | 200 | 100 |
| metal | | | NVMe | | |
| | | | SSD | | |

TABLE 7
Amazon General Purpose EC2 M6a Instances built on
the AWS Nitro System including 3^{rd} Generation AMD
EPYC processors and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M6a/ | 2 | 8 | EBS- | up to 12.5 | up to 10 |
| large | | | Only | | |
| M6a/ | 4 | 16 | EBS- | up to 12.5 | up to 10 |
| xlarge | | | Only | | |
| M6a/ | 8 | 32 | EBS- | up to 12.5 | up to 10 |
| 2xlarge | | | Only | | |
| M6a/ | 16 | 64 | EBS- | up to 12.5 | up to 10 |
| 4xlarge | | | Only | | |
| M6a/ | 32 | 128 | EBS- | 12.5 | 10 |
| 8xlarge | | | Only | | |
| M6a/ | 48 | 192 | EBS- | 18.75 | 15 |
| 12xlarge | | | Only | | |
| M6a/ | 64 | 256 | EBS- | 25 | 20 |
| 16xlarge | | | Only | | |
| M6a/ | 96 | 384 | EBS- | 37.5 | 30 |
| 24xlarge | | | Only | | |
| M6a/ | 128 | 512 | EBS- | 50 | 40 |
| 32xlarge | | | Only | | |
| M6a/ | 192 | 768 | EBS- | 50 | 40 |
| 48xlarge | | | Only | | |
| M6a/ | 192 | 768 | EBS- | 50 | 40 |
| metal | | | Only | | |

TABLE 8
Amazon General Purpose EC2 M5 Instances built on the AWS
Nitro System including Intel Xeon Scalable processor (Skylake
or Cascade Lake) with Intel Advanced Vector Extension (AVX-
512) instruction set and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M5/ | 2 | 8 | EBS- | up to 10 | up to 4,750 |
| large | | | Only | | |
| M5/ | 4 | 16 | EBS- | up to 10 | up to 4,750 |
| xlarge | | | Only | | |
| M5/ | 8 | 32 | EBS- | up to 10 | up to 4,750 |
| 2xlarge | | | Only | | |
| M5/ | 16 | 64 | EBS- | up to 10 | 4,750 |
| 4xlarge | | | Only | | |
| M5/ | 32 | 128 | EBS- | 10 | 6,800 |
| 8xlarge | | | Only | | |
| M5/ | 48 | 192 | EBS- | 12 | 9,500 |
| 12xlarge | | | Only | | |
| M5/ | 64 | 256 | EBS- | 20 | 13,600 |
| 16xlarge | | | Only | | |
| M5/ | 96 | 384 | EBS- | 25 | 19,000 |
| 24xlarge | | | Only | | |
| M5/ | 96 | 384 | EBS- | 25 | 19,000 |
| metal | | | Only | | |
| M5d/ | 2 | 8 | 1 × 75 | up to 10 | up to 4,750 |
| large | | | NVMe | | |
| | | | SSD | | |
| M5d/ | 4 | 16 | 1 × 150 | up to 10 | up to 4,750 |
| xlarge | | | NVMe | | |
| | | | SSD | | |
| M5d/ | 8 | 32 | 1 × 300 | up to 10 | up to 4,750 |
| 2xlarge | | | NVMe | | |
| | | | SSD | | |
| M5d/ | 16 | 64 | 2 × 300 | up to 10 | 4,750 |
| 4xlarge | | | NVMe | | |
| | | | SSD | | |
| M5d/ | 32 | 128 | 2 × 600 | 10 | 6,800 |
| 8xlarge | | | NVMe | | |
| | | | SSD | | |
| M5d/ | 48 | 192 | 2 × 900 | 12 | 9,500 |
| 12xlarge | | | NVMe | | |
| | | | SSD | | |
| M5d/ | 64 | 256 | 4 × 600 | 20 | 13,600 |
| 16xlarge | | | NVMe | | |
| | | | SSD | | |
| M5d/ | 96 | 384 | 4 × 900 | 25 | 19,000 |
| 24xlarge | | | NVMe | | |
| | | | SSD | | |
| M5d/ | 96 | 384 | 4 × 900 | 25 | 19,000 |
| metal | | | NVMe | | |
| | | | SSD | | |

TABLE 9
Amazon General Purpose EC2 M5n Instances built on the AWS
Nitro System including Intel Xeon Scalable processor (Skylake
or Cascade Lake) with support for Intel Neural Network Instructions
(AVX-512 VNNI) and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M5n/ | 2 | 8 | EBS- | up to 25 | up to 4,750 |
| large | | | Only | | |
| M5n/ | 4 | 16 | EBS- | up to 25 | up to 4,750 |
| xlarge | | | Only | | |
| M5n/ | 8 | 32 | EBS- | up to 25 | up to 4,750 |
| 2xlarge | | | Only | | |
| M5n/ | 16 | 64 | EBS- | up to 25 | 4,750 |
| 4xlarge | | | Only | | |
| M5n/ | 32 | 128 | EBS- | 25 | 6,800 |
| 8xlarge | | | Only | | |
| M5n/ | 48 | 192 | EBS- | 50 | 9,500 |
| 12xlarge | | | Only | | |
| M5n/ | 64 | 256 | EBS- | 75 | 13,600 |
| 16xlarge | | | Only | | |
| M5n/ | 96 | 384 | EBS- | 100 | 19,000 |
| 24xlarge | | | Only | | |
| M5n/ | 96 | 384 | EBS- | 100 | 19,000 |
| metal | | | Only | | |
| M5nd/ | 2 | 8 | 1 × 75 | up to 25 | up to 4,750 |
| large | | | NVMe | | |
| | | | SSD | | |
| M5nd/ | 4 | 16 | 1 × 150 | up to 25 | up to 4,750 |
| xlarge | | | NVMe | | |
| | | | SSD | | |
| M5nd/ | 8 | 32 | 1 × 300 | up to 25 | up to 4,750 |
| 2xlarge | | | NVMe | | |
| | | | SSD | | |
| M5nd/ | 16 | 64 | 2 × 300 | up to 25 | 4,750 |
| 4xlarge | | | NVMe | | |
| | | | SSD | | |
| M5nd/ | 32 | 128 | 2 × 600 | 25 | 6,800 |
| 8xlarge | | | NVMe | | |
| | | | SSD | | |
| M5nd/ | 48 | 192 | 2 × 900 | 50 | 9,500 |
| 12xlarge | | | NVMe | | |
| | | | SSD | | |
| M5nd/ | 64 | 256 | 4 × 600 | 75 | 13,600 |
| 16xlarge | | | NVMe | | |
| | | | SSD | | |
| M5nd/ | 96 | 384 | 4 × 900 | 100 | 19,000 |
| 24xlarge | | | NVMe | | |
| | | | SSD | | |
| M5nd/ | 96 | 384 | 4 × 900 | 100 | 19,000 |
| metal | | | NVMe | | |
| | | | SSD | | |

TABLE 10
Amazon General Purpose EC2 M5a Instances built on the
AWS Nitro System including AMD EPYC 7000 Series processors
(AMD EPYC 7571) and a lightweight hypervisor

| | | | | Network | EBS |
|---|---|---|---|---|---|
| Instance | | Memory | Instance | Bandwidth | Bandwidth |
| Type/Size | vCPU | (GiB) | Storage | (Gbps) | (Gbps) |
| M5a/ | 2 | 8 | EBS- | up to 10 | up to 2,880 |
| large | | | Only | | |
| M5a/ | 4 | 16 | EBS- | up to 10 | up to 2,880 |
| xlarge | | | Only | | |
| M5a/ | 8 | 32 | EBS- | up to 10 | up to 2,880 |
| 2xlarge | | | Only | | |
| M5a/ | 16 | 64 | EBS- | up to 10 | 2,880 |
| 4xlarge | | | Only | | |
| M5a/ | 32 | 128 | EBS- | up to 10 | 4,750 |
| 8xlarge | | | Only | | |
| M5a/ | 48 | 192 | EBS- | 10 | 6,780 |
| 12xlarge | | | Only | | |
| M5a/ | 64 | 256 | EBS- | 12 | 9,500 |
| 16xlarge | | | Only | | |
| M5a/ | 96 | 384 | EBS- | 20 | 13,750 |
| 24xlarge | | | Only | | |
| M5ad/ | 2 | 8 | 1 × 75 | up to 10 | up to 2,880 |
| large | | | NVMe | | |
| | | | SSD | | |
| M5ad/ | 4 | 16 | 1 × 150 | up to 10 | up to 2,880 |
| xlarge | | | NVMe | | |
| | | | SSD | | |
| M5ad/ | 8 | 32 | 1 × 300 | up to 10 | up to 2,880 |
| 2xlarge | | | NVMe | | |
| | | | SSD | | |
| M5ad/ | 16 | 64 | 2 × 300 | up to 10 | 2,880 |
| 4xlarge | | | NVMe | | |
| | | | SSD | | |
| M5ad/ | 32 | 128 | 2 × 600 | up to 10 | 4,750 |
| 8xlarge | | | NVMe | | |
| | | | SSD | | |
| M5ad/ | 48 | 192 | 2 × 900 | 10 | 6,780 |
| 12xlarge | | | NVMe | | |
| | | | SSD | | |
| M5ad/ | 64 | 256 | 4 × 600 | 12 | 9,500 |
| 16xlarge | | | NVMe | | |
| | | | SSD | | |
| M5ad/ | 96 | 384 | 4 × 900 | 20 | 13,750 |
| 24xlarge | | | NVMe | | |
| | | | SSD | | |

### Example Instance-Type Recommendation Pipeline

FIG. 4 is a high-level flow diagram illustrating a set of operations that may be part of an instance-type recommendation pipeline in accordance with various embodiments of the present disclosure. The processing described with reference to FIG. 4, may be performed by an instance-type recommendation system (e.g., instance-type recommendation system 110 or 210) operable within a cloud provider or within a third-party computing platform (e.g., computing platform 102) that is operated independently of the cloud provider. In one embodiment, the third-party computing platform may be part of a cloud analytics or recommendation platform utilized by cloud customers (e.g., customers 104a-n). In other examples the third-party computing platform may be part of a service offering (e.g., NetApp's Spot cloud automation solution, available from NetApp, Inc. of San Jose, CA) that provides cloud customers with recommendations based on various forms of cloud analytics and also facilitates automation and/or optimization of cloud customers' cloud infrastructure in one or more cloud platforms (e.g., cloud system 106, non-limiting examples of which include AWS, Azure, and GCP).

At block 410, data may be collected over time regarding cloud customer ITG usage in the context of one or more cloud platforms. For example, an instance-type group data collector (e.g., instance-type group data collector 211) implemented within the instance-type recommendation system may periodically query the one or more cloud platforms for information regarding ITGs specified by their respective customers for the customer's cloud workloads. Alternatively or additionally, the instance-type group data collector may receive information regarding current ITGs of cloud customers directly from the cloud customers or otherwise be in a position to observe such information, for example, as a result making ITG recommendations to cloud customers, submitting ITGs to the one or more cloud platforms on behalf of the cloud customers, submitting workload deployment requests on behalf of cloud customers, and/or the like. As discussed above, the collected cloud customer ITG usage information may be persisted for use as part of an ML training process. In addition, the instance-type group data collection may also obtain information regarding instance types available from the one or more cloud platforms as well as their associated attributes.

At block 420, a recommendation system may be trained based on the collected data. For example, a training module (e.g., training module 213) may train an ML model (e.g., ML model 215) to recognize similarities among and between various instance types by breaking the instance types of current ITGs that are being used by cloud customers into the features (e.g., {instance family, generation, special features, size, vCPU, GPU type, memory capacity, Ena type, network performance, max Enis, virtualization type, architecture type, hypervisor, storage capacity, and vCPU information}) which may then be encoded by an encoder of the ML model. A non-limiting example of training of the ML model is described further below with reference to FIG. 5.

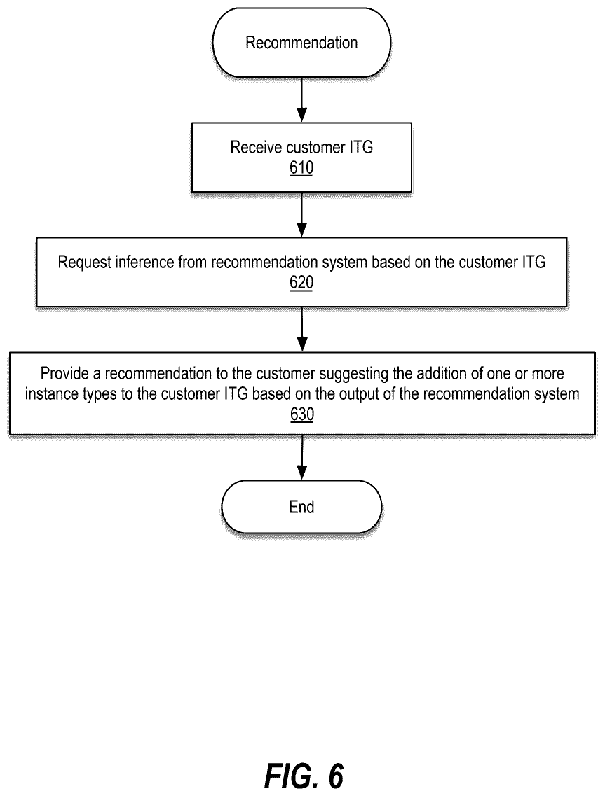

At block 430, based on an input ITG (e.g., a cloud customer's current ITG), one or more new instance types may be output as a recommendation to be added to the input ITG. For example, a request processing module (e.g., request processing module 217) may receive a recommendation request from a cloud customer that includes information regarding their current ITG for a particular cloud platform. The request processing module may then request the ML model to perform inference processing to provide an instance-type recommendation on behalf of the cloud customer based on the supplied ITG. In one example, the output produced by the ML model in response to an inference request may be a list of one or more instance types recommended to be added to the input ITG and the one or more instance types of the list may be provided in a prioritized fashion, for example, ranked in descending order in terms of the degree of similarity of the instance types to those instance types within the input ITG. A non-limiting example of providing an instance-type recommendation is described further below with reference to FIG. 6.

### Example Training Approach

FIG. 5 is a flow diagram illustrating a set of operations for training a machine-learning (ML) model in accordance with an embodiment of the present disclosure. Depending on the particular implementation, the ML model may be trained on a per-cloud platform basis for use in connection with a number of cloud platforms or for a single cloud platform. The ML model may take into consideration current and/or historical data observed during interactions among the cloud customers and the cloud platform at issue and/or current or historical data collected from the cloud platform at issue, including, for example, instance types offered by the cloud platform(s) and associated attributes (e.g., hardware specifications) of the instance types.

At block 510, a first/next training iteration of the ML model (e.g., ML model 215) made is performed based on (i) current and/or historical data (e.g., persisted in database 112) regarding instance types specified by cloud customers (e.g., customers 104a-n) as part of their respective ITGs in connection with running their cloud workloads, for example, on the particular cloud platform and (ii) available instance types (e.g., instance types 102a-n) offered by the particular cloud platform.

At block 520, an optimization algorithm is applied to the ML model. For example, the ML model's predictive performance may be evaluated and optimizations may be performed, for example, through backpropagation, to minimize a cost function and/or a loss function.

At decision block 530, a determination may be made regarding whether a predetermined or configurable training iteration threshold has been achieved. If so, training processing is complete; otherwise, processing branches to block 540. The training iteration threshold may be a function of the number of instance types offered by the cloud platform at issue. For example, features relating to each instance type of a given set of two or more instance types offered by the cloud provider may be used as input during respective training iterations. According to one embodiment, during each training iteration the ML model may be trained to recognize similarities and/or differences between or among two or more instance types of the instance types offered by the cloud platform at issue. For example, feature engineering may be performed to represent the instance types in terms of their respective attributes (e.g., individual elements of their respective hardware specifications) and using such attributes as features during training of the ML model.

At block 540, the iterator(s) are incremented and processing loops back to block 510 to perform the next training iteration. According to one embodiment, the iterator(s) may include one or more of a desired number of training cycles and/or a number of distinct or randomly-selected ITGs including a subset of some minimum number of the offered instance types by the particular cloud platform.

A non-limiting example of an ML model training flow is provided below with reference to Algorithm #1.

While in the context of the present example, the ML model is described as being trained based on current and/or historical data regarding customer ITGs and instance types offered by a given cloud platform (e.g., cloud system 106), it is to be appreciated to the extent additional data (e.g., attributes of cloud customers) is available to the computing platform, such additional data may be used to improve instance type recommendations for cloud customers, for example, by including such additional data in the training so as to give greater weight to instance types utilized by cloud customers that are similar to the cloud customer at issue.

### Algorithm #1—Example ML Model Training Workflow

For purposes of completeness, a non-limiting pseudo code example of a training flow that may be performed by an instance type recommendation system (e.g., instance-type recommendation system 110 or 210) to train or re-train, as the case may be, an ML model (e.g., machine-learning model 215). In embodiment, the ML model (which may be referred to herein as “TripleNet”) comprises an encoder having a two-layer MLP architecture, with ReLU activation and is trained using a triplet loss approach. Triplet loss is a machine learning loss function in which a reference input (referred to as the anchor) is compared to a matching input (referred to as the positive) and a non-matching input (referred to as the negative). The objective is to minimize the distance between the anchor and the positive input while maximizing the distance between the anchor and the negative input.

An example of a training flow using the triplet loss approach is as follows (in which TripleNet is referred to as T and the sample ITGs may include current ITGs in use by a large group of cloud customers):
1. Inputs: Optional (available) instance types I, comprising {I₁, . . . , I_{M}} and sample Instance Type Groups (ITGs), referred to as ITG, which includes {A₁, . . . , A_{M}}. In this example, each ITG, Ai, represents a subset of I, containing a minimum of three instance types.
2. For epoch {1, . . . , k}:
3. For i in {1, . . . , M}:
4. Randomly sample two instance types from the set Aᵢ, name them I_{A}_{ᵢ}_{,1}, I_{A}_{ᵢ}_{,2}
5. Choose an instance type at random that is not part of the set Aᵢ, name it I_{˜A}_{ᵢ}
6. Represent these three instance types by breaking them down into the following features which are encoded by an encoder: {instance family, generation, special features, size, vCPU, GPU type, memory capacity, Ena type, network performance, max Enis, virtualization type, architecture type, hypervisor, storage capacity, and vCPU information}
7. Apply T to obtain: anchor=T(I_{A}_{ᵢ}_{,1}), positive=T(I_{A}_{ᵢ}_{,2}), negative=T(I_{˜A}_{ᵢ})
8. Optimize T through Backpropagation, minimizing the triplet loss function:

$$triplets - loss ( anchor , positive , negative )$$

While in the context of various example, the ML model may be described as being trained based on the instance types offered by a particular cloud provider and sample ITGs representing various combinations of multiple of the offered instance types, it is to be appreciated in other example, the training flow may additionally or alternatively make use of actual ITGs utilized by corresponding cloud customers and during the training the cloud customers may be represented in terms of features corresponding to their respective attributes to allow similarities and/or differences among cloud customers to be learned and used as a contributing factor to the instance type recommendations.

A non-limiting example of code representing triplet loss is as follows:

```
import torch
import torch.nn as nn
import torch.nn.functional as F
class TripletLoss(nn.Module):
  def_init_(self, margin=1.0):
    super(TripletLoss, self)._init_( )
    self.margin = margin
  def forward(self, anchor, positive, negative):
    positive_distance = 1 −
F.cosine_similarity(anchor, positive)
    negative_distance = 1 −
F.cosine_similarity(anchor, negative)
    loss_triplet =
torch.mean(torch.clamp(positive_distance −
negative_distance + self.margin, min=0.0))
  return loss_triplet
```

### Example Run-Time Recommendation Processing

FIG. 6 is a flow diagram illustrating a set of operations for providing an instance-type recommendation in accordance with an embodiment of the present disclosure.

At block 610, the instance-type recommendation system receives information regarding a cloud customer's ITG, for example, to be used to run a workload in a given cloud platform (e.g., cloud system 106). Depending on the relationship between the cloud customer and the computing platform may receive the ITG as part of a request proxied by the computing platform to the cloud platform or may receive the ITG as part of monitoring of the cloud platform on behalf of the cloud customer. Alternatively, prior to the cloud customer making a request to the cloud platform, the cloud customer may seek an instance-type recommendation from the computing platform based on an ITG supplied by the cloud customer.

At block 620, the computing platform may request an inference from the instance-type recommendation system based on the cloud customer's ITG and a trained ML model (e.g., machine-learning model 215 or 350) trained, for example, as described above with reference to FIG. 5. The inference results from the trained ML model may return a ranked list of suitable instance types suggested to be added to the ITG. A non-limiting example of an inferencing or recommendation process is provided below with reference to Algorithm #2.

At block 630, the computing platform may provide a recommendation to the cloud customer to add one or more instance types to the cloud customer's ITG based on the output (e.g., the ranked list of instance types) of the instance-type recommendation system.

While in the context of the present example, the trained ML model is described as performing an inference based on a given ITG and its prior training, it is to be appreciated in other examples the inference may further be based on attributes of the workload and/or attributes of the cloud customer at issue.

While in the context of the flow diagrams of FIGS. 4-6 a number of enumerated blocks are included, it is to be understood that examples may include additional blocks before, after, and/or in between the enumerated blocks. Similarly, in some examples, one or more of the enumerated blocks may be omitted and/or performed in a different order.

### Algorithm #2—Example Inference (Recommendation Process)

For purposes of completeness, a non-limiting pseudo code example of a recommendation process that may be performed by an instance type recommendation system (e.g., instance-type recommendation system 110 or 210) to output one or more recommended instance types to be added to (or removed from) a given ITG. In one embodiment, the ML model (e.g., ML model 215 or 350) that performs the inferencing is “TripleNet” described above.

An example of an inferencing workflow using TripleNet, which is referred to as T, is provided below (in which the input ITG A of a cloud customer includes N instance types and L represents the size of the pool of all available instance types within the cloud platform at issue):
1. Input: ITG A={I₁, . . . , I_{N}} for which a recommended new instance type to be added is sought.
2. For j in {N+1, . . . , L}:
3.

$${sim}_{j} = \frac{1}{N} {\sum }_{t = 1}^{N} similarity ( T ( {I}_{j} ) , T ( {I}_{t} ) )$$

where similarity is the cosine-similarity measure
4. The recommended instance type is arg max (sim_{N+1}, . . . , sim_{L}). Rephrased, the instance type whose similarity value, denoted as sim, was the highest

### Example Computer System

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 7 is a block diagram that illustrates a computer system 700 in which or with which an embodiment of the present disclosure may be implemented. Computer system 700 may be representative of all or a portion of one or more computing systems utilized by a computing platform (e.g., computing platform 102) to perform, among other things, the training and inference processing performed herein. Notably, components of computer system 700 described herein are meant only to exemplify various possibilities. In no way should example computer system 700 limit the scope of the present disclosure. In the context of the present example, computer system 700 includes a bus 702 or other communication mechanism for communicating information, and one or more processing resources (e.g., one or more hardware processors 704) coupled with bus 702 for processing information. Hardware processor(s) 704 may be, for example, a general purpose microprocessor.

Computer system 700 also includes a main memory 706, such as a random access memory (RAM) or other dynamic storage device, coupled to bus 702 for storing information and instructions to be executed by processor(s) 704. Main memory 706 also may be used for storing temporary variables or other intermediate information during execution of instructions to be executed by processor(s) 704. Such instructions, when stored in non-transitory storage media accessible to processor(s) 704, render computer system 700 into a special-purpose machine that is customized to perform the operations specified in the instructions.

Computer system 700 further includes a read only memory (ROM) 708 or other static storage device coupled to bus 702 for storing static information and instructions for processor(s) 704. A storage device 710, e.g., a magnetic disk, optical disk or flash disk (made of flash memory chips), is provided and coupled to bus 702 for storing information and instructions.

Computer system 700 may be coupled via bus 702 to a display 712, e.g., a cathode ray tube (CRT), Liquid Crystal Display (LCD), Organic Light-Emitting Diode Display (OLED), Digital Light Processing Display (DLP) or the like, for displaying information to a computer user. An input device 714, including alphanumeric and other keys, is coupled to bus 702 for communicating information and command selections to processor(s) 704. Another type of user input device is cursor control 716, such as a mouse, a trackball, a trackpad, or cursor direction keys for communicating direction information and command selections to processor(s) 704 and for controlling cursor movement on display 712. This input device typically has two degrees of freedom in two axes, a first axis (e.g., x) and a second axis (e.g., y), that allows the device to specify positions in a plane.

Removable storage media 740 can be any kind of external storage media, including, but not limited to, hard-drives, floppy drives, IOMEGA® Zip Drives, Compact Disc—Read Only Memory (CD-ROM), Compact Disc-Re-Writable (CD-RW), Digital Video Disk—Read Only Memory (DVD-ROM), USB flash drives and the like.

Computer system 700 may implement the techniques described herein using customized hard-wired logic, one or more ASICs or FPGAs, firmware or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 710. Volatile media includes dynamic memory, such as main memory 706. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor(s) 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor(s) 704 retrieve and execute the instructions. The instructions received by main memory 706 may optionally be stored on storage device 710 either before or after execution by processor(s) 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor(s) 704 as it is received, or stored in storage device 710, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
maintaining information regarding a plurality of attributes of a plurality of instance types available to run workloads on behalf of customers of a cloud platform;
obtaining information regarding current instance-type groups (ITGs) utilized by a set of the customers, wherein a given ITG of the current ITGs identifies one or more instance types of the plurality of instance types on which it is permissible for the cloud platform to run a workload of a respective customer of the set of customers;
training a multi-layer perceptron (MLP) neural network by breaking the instance types of the current ITGs down into their respective plurality of attributes and causing the MLP network to encode the plurality of attributes as features; and
automatically tuning an ITG of a given customer of the customers for a workload of the given customer to be run in the cloud platform by obtaining a recommendation from the MLP neural network model based on the ITG,
wherein the recommendation includes one or more instance types of the plurality of instance types, wherein the one or more instance types have a highest relative cosign similarity measure in relation to an instance type identified by the ITG as compared to the cosign similarity measure of the instance type in relation to all other instance types of the plurality of instance types, and wherein said automatically tuning includes adding the one or more instance types to the ITG.

2. The method of claim 1, wherein one or more of said maintaining, training, and automatically tuning are performed by a service provider operating separately from the cloud platform.

3. The method of claim 1, wherein one or more of said maintaining, training, and automatically tuning are performed by the cloud platform.

4. The method of claim 1, wherein the plurality of attributes include compute, memory, storage, and networking capacity metrics.

5. The method of claim 1, wherein the plurality of attributes include information regarding an instance family, a type of virtual central processing unit (vCPU), a type of graphics processing unit (GPU), a memory capacity, a network adapter type, information regarding network performance, a maximum number of network interfaces, a virtualization type, an architecture type, and a hypervisor type.

6. The method of claim 1, wherein training of the MLP neural network makes use of a triplet loss function that minimizes a distance between an anchor and a positive input while maximizing a distance between the anchor and a negative input.

7. The method of claim 1, wherein training of the MLP neural network makes use of a contrastive loss function that maximizes agreement between positive pairs and minimizes agreement between negative pairs a learned embedding space.

8. A non-transitory machine readable medium storing instructions, which when executed by one or more processing resources of one or more computer systems, cause the one or more computer systems to:
maintain information regarding a plurality of attributes of a plurality of instance types available to run workloads on behalf of customers of a cloud platform;
obtain information regarding current instance-type groups (ITGs) utilized by a set of the customers, wherein a given ITG of the current ITGs identifies one or more instance types of the plurality of instance types on which it is permissible for the cloud platform to run a workload of a respective customer of the set of customers;
train a multi-layer perceptron (MLP) neural network by breaking the instance types of the current ITGs down into their respective plurality of attributes and causing the MLP network to encode the plurality of attributes as features;
automatically tune an ITG of a given customer of the customers for a workload of the given customer to be run in the cloud platform by obtaining a recommendation from the MLP neural network model based on the ITG, wherein the recommendation includes one or more instance types of the plurality of instance types, wherein the one or more instance types have a highest relative cosign similarity measure in relation to an instance type identified by the ITG as compared to the cosign similarity measure of the instance type in relation to all other instance types of the plurality of instance types, and wherein said automatically tuning includes adding the one or more instance types to the ITG.

9. The non-transitory machine readable medium of claim 8, wherein the plurality of attributes include compute, memory, storage, and networking capacity metrics.

10. The non-transitory machine readable medium of claim 8, wherein the plurality of attributes include information regarding an instance family, a type of virtual central processing unit (vCPU), a type of graphics processing unit (GPU), a memory capacity, a network adapter type, information regarding network performance, a maximum number of network interfaces, a virtualization type, an architecture type, and a hypervisor type.

11. The non-transitory machine readable medium of claim 8, wherein training of the MLP neural network makes use of a triplet loss function that minimizes a distance between an anchor and a positive input while maximizing a distance between the anchor and a negative input.

12. The non-transitory machine readable medium of claim 8, wherein training of the MLP neural network makes use of a contrastive loss function that maximizes agreement between positive pairs and minimizes agreement between negative pairs a learned embedding space.

13. The non-transitory machine readable medium of claim 8, wherein at least a subset of the one or more computer systems are operable by a service provider operating separately from the cloud platform and wherein maintaining of the information regarding the plurality of attributes, training of the MLP neural network, or automatic tuning of the ITG of a given customer are performed by the service provider.

14. The non-transitory machine readable medium of claim 8, wherein at least a subset of the one or more computer systems are part of the cloud platform and wherein maintaining of the information regarding the plurality of attributes, training of the MLP neural network, or automatic tuning of the ITG of a given customer are performed by the cloud platform.

15. A system comprising:
one or more processing resources; and
instructions that when executed by the one or more processing resources cause the system to:
maintain information regarding a plurality of attributes of a plurality of instance types available to run workloads on behalf of customers of a cloud platform;
obtain information regarding current instance-type groups (ITGs) utilized by a set of the customers, wherein a given ITG of the current ITGs identifies one or more instance types of the plurality of instance types on which it is permissible for the cloud platform to run a workload of a respective customer of the set of customers;
train a multi-layer perceptron (MLP) neural network by breaking the instance types of the current ITGs down into their respective plurality of attributes and causing the MLP network to encode the plurality of attributes as features;
automatically tune an ITG of a given customer of the customers for a workload of the given customer to be run in the cloud platform by obtaining a recommendation from the MLP neural network model based on the ITG, wherein the recommendation includes one or more instance types of the plurality of instance types, wherein the one or more instance types have a highest relative cosign similarity measure in relation to an instance type identified by the ITG as compared to the cosign similarity measure of the instance type in relation to all other instance types of the plurality of instance types, and wherein said automatically tuning includes adding the one or more instance types to the ITG.

16. The system of claim 15, wherein the plurality of attributes include compute, memory, storage, and networking capacity metrics.

17. The system of claim 15, wherein the plurality of attributes include information regarding an instance family, a type of virtual central processing unit (vCPU), a type of graphics processing unit (GPU), a memory capacity, a network adapter type, information regarding network performance, a maximum number of network interfaces, a virtualization type, an architecture type, and a hypervisor type.

18. The system of claim 15, wherein training of the MLP neural network makes use of a triplet loss function that minimizes a distance between an anchor and a positive input while maximizing a distance between the anchor and a negative input.

19. The system of claim 15, wherein training of the MLP neural network makes use of a contrastive loss function that maximizes agreement between positive pairs and minimizes agreement between negative pairs a learned embedding space.

20. The system of claim 15, wherein the system supports a service offering of the cloud platform that performs one or more of automatic scaling, launching, managing, and monitoring of fleets of instances on behalf of the customers.

21. A method comprising:
maintaining, by a cloud platform, information regarding current instance-type groups (ITGs) utilized by a plurality of customers of the cloud platform, wherein a given ITG of the current ITGs identifies one or more instance types of the plurality of instance types on which it is permissible for the cloud platform to run a workload of a respective customer of the plurality of customers;
training, by the cloud platform, a multi-layer perceptron (MLP) neural network by breaking a given instance type of the current ITGs down into a plurality of attributes and causing the MLP network to encode the plurality of attributes as features of the given instance type, wherein the training makes use of a loss function that minimizes a distance between an anchor and a positive input while maximizing a distance between the anchor and a negative input; and
automatically tuning, by the cloud platform, an ITG of a given customer of the customers for a workload of the given customer to be run in the cloud platform by obtaining a recommendation from the MLP neural network model based on the ITG, wherein the recommendation includes one or more instance types of the plurality of instance types, wherein the one or more instance types have a highest relative cosign similarity measure in relation to an instance type identified by the ITG as compared to the cosign similarity measure of the instance type in relation to all other instance types of the plurality of instance types, and wherein said automatically tuning includes adding the one or more instance types to the ITG.
